(19) United States
(12) Patent Application Publication
(10) Pub. No.: US 2015/0054616 A1
(43) Pub. Date: Feb. 26, 2015

(54) SYSTEM AND METHOD FOR ENTRANCE CONTROL TO SECURED PREMISES

(71) Applicant: FST21 LTD., Ramat Hahayal (IL)

(72) Inventors: Ofir Friedman, Rishon Le-Zion (IL); Ido Shlomo, Tel-Aviv (IL); Amnon Shachar, Ra'anana (IL); Avi Lerer, Kfar Chabad (IL); Shahar Belkin, Moshav Kochav Michael (IL)

(21) Appl. No.: 14/378,336

(22) PCT Filed: Feb. 13, 2013
(86) PCT No.: PCT/IL13/50135

§ 371 Date: Aug. 13, 2014

Related U.S. Application Data
(60) Provisional application No. 61/598,650, filed on Feb. 14, 2012.

(51) Int. Cl. G07C 9/00

(52) U.S. Cl. CPC G07C 9/00158; G07C 9/00103; G07C 9/00031
USPC 340/5.53

(57) ABSTRACT

A system and method for entrance control to secured premises is disclosed. The entrance control system may comprise an entrance control unit; an authorization system comprising a control center; a premises entrance unit, located proximal to the entrance control unit; the premises entrance unit comprising a checkpoint unit and an optical unit, wherein the checkpoint unit is operatively connected to the optical unit and to the control center; and wherein the checkpoint unit is configured to receive a first input from the optical unit and a second input from the control center, and to output an authorized/non-authorized visitor signal based on the first input and the second input. A method for entrance control is also disclosed.

### BACKGROUND OF THE INVENTION

Entrance control systems as known in the art, for screening out unauthorized persons and allowing entrance to authorized persons suffer of several drawbacks. Such systems typically require relatively long time before authorization is confirmed or denied, thus creating bottle neck when the stream of persons wishing to enter grows. The screening, authorization and entry allowance process is typically cumbersome, and requires presentation of identification means (e.g. ID card), waiting for verification, receiving a temporary entrance certificate (visitor tag or the like), leaving a personal belonging such as driving license) to ensure reporting at the checkpoint at the end of the visit, etc.

There is a need for a more fluent process that will support accurate screening of persons at a checkpoint but will simplify and shorten the existing process without diminishing the level of security (as may be measured by the level of false negative and false positive alarms).

### SUMMARY OF EMBODIMENTS OF THE INVENTION

Embodiments of the present invention provide an entrance control system comprising an entrance control unit; an authorization system comprising a control center; a premises entrance unit, located at or proximal to the entrance control unit.

The premises entrance unit may comprise, according to some embodiments of the present invention, a checkpoint unit and an optical unit, wherein the checkpoint unit is operatively connected to the optical unit and to the control center; and the checkpoint unit is configured to receive a first input from the optical unit, such as a unique graphical code and/or a face image of a visitor, and a second input from the control center, such as pre-obtained and pre-stored information regarding a visitor, and to output an authorized/non-authorized visitor signal based on the first input and the second input.

According to some embodiments of the present invention, the entrance control system may further comprise an authorizing person's terminal and a visitor's terminal.

The control center, according to some embodiment of the present invention, is operatively connected to the visitor's terminal and the authorizing person's terminal, for example via a communication channel or network.

According to some embodiments, the optical unit may comprise at least one of a still camera, a video camera and a graphical code reader.

According to other or additional embodiments of the present invention the first input received from the optical unit may comprise at least on of a face image of a visitor and a reading of a graphical code presented by the visitor to the optical unit.

The entrance control system according to claim 5 wherein said graphical code is displayed on a screen of said visitor's terminal.

The entrance control system according to any one of the preceding claims wherein said second input is pre-stored information associated with an invitation.

According to some embodiments, the pre-stored information may comprise at least one of a face image of an invitee and a unique graphical code associated with the invitation of the invitee.

The graphical code according to embodiments of the present invention may comprise identification information of invitee and invitation information.

Embodiments of the present invention further provide a method for entrance control to a secured premises, the method may comprise receiving at a control center invitation details of an invitee; issuing an invitation to the invitee; the invitation comprising a graphical code; receiving at the control center a confirmation of invitation; directing a visitor at the secured premises to present identification information to an optical unit located at or proximal to a gateway to the secured premises; analyzing the identification information to verify visitor's authorization to enter the secured premises; and issuing a door-open authorization signal upon successful identification of invitee or confirming a visitor by an authorizing person when the identification of the visitor is unsuccessful.

According to some embodiments of the present invention, the identification information may comprise the unique graphical code and a face image of the visitor.

According to some embodiments, the face image is obtained by the optical unit.

According to embodiments of the present invention, the analyzing of the identification information may comprise obtaining pre-stored information regarding the identity of an invitee from a storage at the control center; and comparing the pre-stored information with the identification information received from the optical unit.

According to some embodiments the invitation further comprises a request to receive a face image of invitee.

The method according to some embodiments may further comprise receiving a face image of invitee sent by invitee in response to the request.

According to some embodiments the pre-stored information may comprise one or more of the unique graphical code sent to the invitee, a face image of invitee received from invitee, and invitation details.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of an authorization system according to embodiment of the present invention; and

FIG. 2 is a schematic flow chart illustrating a method of operation of an authorization system according to embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

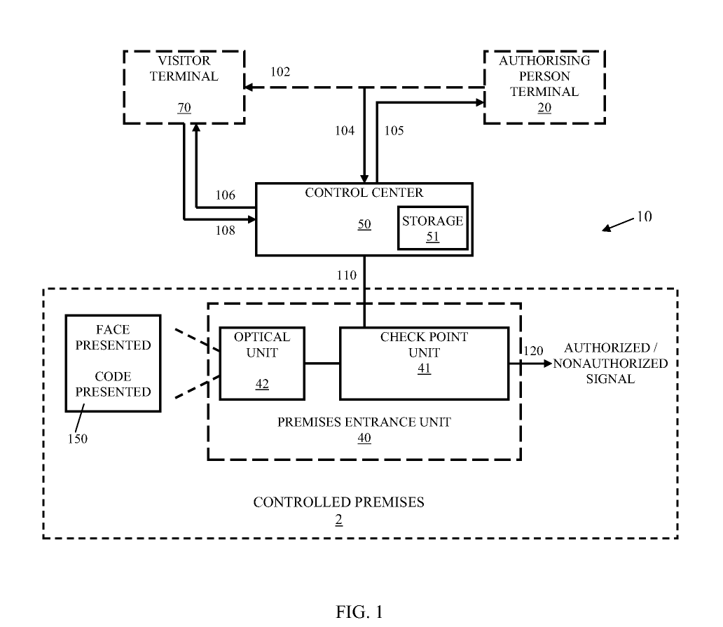

Reference is made now to FIG. 1, which is a schematic illustration of entrance control system 10 according to embodiment of the present invention. System 10 may be located and operated with regards to one or more controlled premises 2, such as a business or residence premises or a secured premises, which requires efficient and high-reliability entrance control system.

Controlled premises 2 comprise entrance control checkpoint such as door, gate, lobby and the like (not shown). Authorization system 10 may comprise control center 50; premises entrance unit 40 located at or proximal to the entrance control checkpoint of controlled premises 2 and comprising checkpoint unit 41 and optical unit 42, where optical unit 42, such as still camera, video camera, imaging unit and the like, may be located at or proximal to the entrance control checkpoint of controlled premises 2 so that a person approaching the checkpoint reaches the field of view of optical unit 42 at least at a range of 2-4 meters and so that the person's face is located well within that field of view. Control center 50 comprising storage means 51 that is adapted to store program commands and data. Storage means 51 may comprise program code that, when executed, causes system 10 to perform steps as described herein below. Control center 50 may be operatively connected with premises entrance unit 40, for example via communication channel 110, to provide data associated with authorization information, such as invitee details, invitee face image and invitee unique graphical code 150. Control center 50 may be operatively connected with an authorizing person's terminal 20, for example via communication channels 104, 105 and with visitor's terminal 70, for example via communication channels 106, 108.

Authorizing person may be any person having authorization to authorize entrance of a visitor to controlled premises 2, such as an official person of premises 2, a tenant of premises 2, and the like. A visitor may be any person who needs or wants to enter, or is invited into premises 2. Control center 50 may be realized in hardware and software located away from premises 2, or it may be realized as program executed on a hosting computer, in a computation cloud, etc. Authorizing person's terminal 20 and visitor's terminal 70 may be realized as a dedicated terminal, as an application saved and executed on a stationary computer or on a portable computer, such as personal digital assistant (PDA), Smartphone, tablet computer, laptop computer and the like.

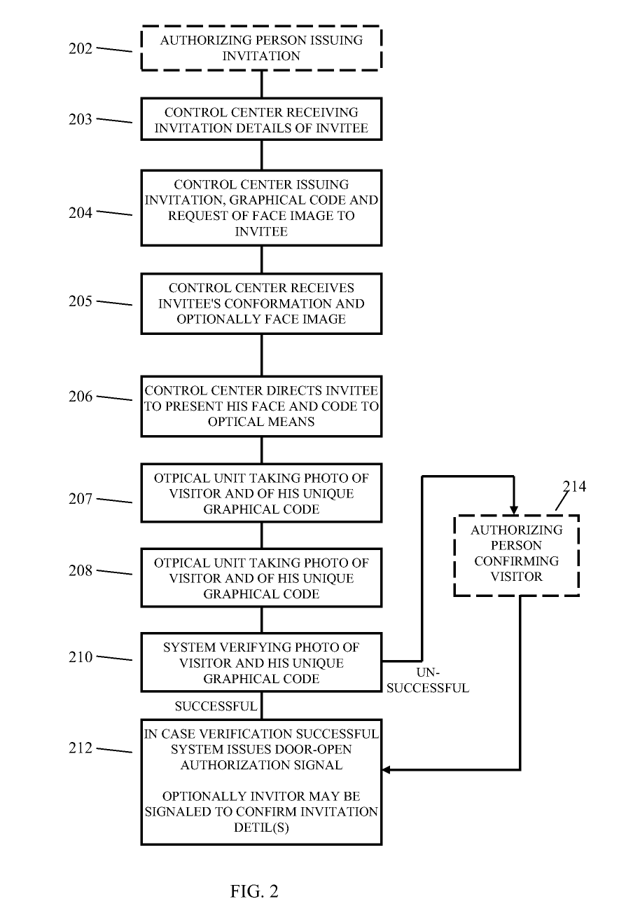

According to embodiments of the present invention, authorization to enter premises 2 may be processed following an invitation issued by an authorizing person, or in response to a request issued by a visitor. Reference is made now also to FIG. 2, which is a schematic flow chart illustrating a method of operation of authorization system 10 according to embodiments of the present invention. When an authorizing person wishes to grant entrance authorization into premises 2 to a visitor, he/she may send a message to control center 50 advising details of the invitee and the invitation, such as invitee identification, invitation date and time, etc. (block 202). The invitation initiated by the authorizing person is received by control center 50 (block 203). According to some embodiments, control center 50 may issue a message in response to the invitation initiation. The message may be in the form a meeting coordination message, such as that produced by Outlook® of Microsoft Inc. or similar platforms.

According to embodiments of the present invention, a software program may be available to the authorizing person's terminal 20, which may be activated automatically by the invitation message or manually as part of the invitation process. That software program may be installed and running on terminal 20, or may be realized as a service available on remote facilities (such as cloud computation facility and the like) via any known communication channel, such as the Internet or may be running in control center 50, and the like. When operated automatically, the activation of that program may be, for example, by the addition of the name of a generic faked invitee enlisted as a legitimate outlook address that, when invited to participate in the meeting, activates a software program that creates a unique graphical code 150 (one for each invitee). Graphical code 150 may be in the form of a quick response (QR) Code, UFC barcode or the like. The graphical code may be in any known format allowing embedding general and personal information in it in a way optically presentable on a terminal screen or printed and presentable as printed graphical code on a paper or the like. Unique graphical code may be attached to the message sent to the authorized invitee and may be associated uniquely with that invitee and with that invitation, in any known manner (attached graphical file, embedded in the message for immediate presentation, and the like).

According to embodiments of the present invention, extra secured level may be obtained by the issuance, with the invitation message and graphical code 150 sent to the invitee, a demand to provide a face picture of the invitee to control system 50, for example via communication channel 108 (block 204). In response, the invitee may send an invitation confirmation and optionally picture of his/her face, to be received by control center 50 (block 205). The face picture, or image, of the invitee, when received, may be stored in storage means, such as storage means 51. According to embodiments of the invention, the invitee face image may further be compared for authentication with an existing face image pre-stored in control system 10. When the invitee approaches the checkpoint of premises 2, he/she may be directed to present, within the field of view of optical unit 42, his/her face and his/her graphical code 150 (block 206). Graphical code 150 may be presented to optical unit 42 printed on a paper or the like or presented on the screen of invitee terminal 70. Specific distance range for acceptable results of the images taken by optical unit 42, specific range of quality of graphical code 150 when presented to optical unit 42, specification of lighting available at the location where invitee is directed to be for taking the photos, etc. may vary with the actual performance of optical unit 42, with the requirements exerted on the overall performance, time-wise, on system 10, etc. As measured and calculated by the inventors of the present invention the identification process and comparison is under 3 seconds.

Optical unit 42 may take one or more photos of invitee face and of graphical code 150 (block 208). Check point unit 41 may receive the photos taken at block 208 and process them in order to verify their authenticity and their match to information associated with the respective invitation, such as name of invitee and time slot of the respective meeting (block 210). Check point unit 41 may initiate communication to control center 50 in order further verify the graphical data received from optical unit 42. For example, check point unit 41 may send the graphical information for farther verification if the level of authentication processed at check point unit 41 is below a defined level.

When authentication and verification completes successfully, control center 50 may issue a signal allowing the entrance of the invitee into premises 2 (block 212). The signal may be in the form of directly opening a door, or a signal (visual/aural) to the gatekeeper signaling to open a door, etc. When the verification is unsuccessful (i.e., the graphical information face image and graphical code) is not sufficient for issuing entrance permission, for example when a visitor wishes to enter premises without pre-issued invitation, thus he/she is not equipped with graphical code, check point unit 41 may initiate connection to an authorizing person, for example over the phone, via email, via SMS etc., asking him to confirm the request to enter premises 2. In case such conformation is given control center 50 may issue a signal allowing the entrance of the visitor into premises 2 (block 212).

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. An entrance control system comprising:
an entrance control unit;
an authorization system comprising a control center;
a premises entrance unit, located proximal to said entrance control unit;
said premises entrance unit comprising a checkpoint unit and an optical unit, wherein said checkpoint unit is operatively connected to said optical unit and to said control center; and
wherein said checkpoint unit is configured to receive a first input from said optical unit and a second input from said control center, and to output an authorized/non-authorized visitor signal based on said first input and said second input.

2. The entrance control system according to claim 1 further comprising an authorizing persons terminal and a visitor's terminal.

3. The entrance control system according to claim 2 wherein said control center is operatively connected to said visitor's terminal and said authorizing person's terminal.

4. The entrance control system according to claim 1 wherein said optical unit comprising at least one of a list including: a still camera; a video camera and a graphical code reader.

5. The entrance control system according to claim 4 wherein said first input comprising at least one of a face image of a visitor and a reading of a graphical code presented by said visitor to said optical unit.

6. The entrance control system according to claim 5 wherein said graphical code is displayed on a screen of said visitor's terminal.

7. The entrance control system according to claim 1 wherein said second input is pre-stored information associated with an invitation.

8. The entrance control system according to claim 7 wherein said pre-stored information comprises at least one of a face image of an invitee and a graphical code associated with said invitation of said invitee.

9. The entrance control system according to claim 8 wherein said graphical code comprises identification information of invitee and invitation information.

10. A method for entrance control to a secured premises, the method comprising:
receiving at a control center invitation details of an invitee;
issuing an invitation to the invitee; the invitation comprising a graphical code;
receiving at said control center a confirmation of invitation;
directing a visitor at said secured premises to present identification information to an optical unit located proximal to a gateway to said secured premises;
analyzing said identification information to verify visitor's authorization to enter the secured premises; and
issuing a door-open authorization signal upon successful identification of invitee.

11. The method according to claim 10 wherein said identification information comprise said graphical code and a face image of said visitor.

12. The method according to claim 11 wherein said face image is obtained by said optical unit.

13. The method according to claim 12 wherein said analyzing of said identification information comprise:
obtaining pre-stored information regarding the identity of an invitee from a storage as said control center; and
comparing said pre-stored information with the identification information received from said optical unit.

14. The method according to claim 10 wherein said invitation further comprises a request to receive a face image of invitee.

15. The method according to claim 14 further comprising receiving a face image of invitee sent by invitee in response to said request.

16. The method according to claim 15 wherein said pre-stored information comprises one or more of the unique graphical code sent to the invitee, a face image of invitee received from invitee, and invitation details.

17. The method according to claim 10 further comprising confirmation of a visitor by an authorizing person when the identification of said visitor is unsuccessful.
